(19) United States
(12) Patent Application Publication
(10) Pub. No.: US 2011/0129803 A1
(43) Pub. Date: Jun. 2, 2011

(54) Parallel parking apparatus/vehicle perimeter marking system

(76) Inventor: Scott Lane Gallagher, Hamilton, NJ (US)

(21) Appl. No.: 12/592,681

(22) Filed: Dec. 2, 2009

(51) Int. Cl. G09B 19/16

(52) U.S. Cl. 434/66

(57) ABSTRACT

The parallel parking system/vehicle perimeter marking apparatus is to be used to teach drivers the perimeter of their vehicle through visual aids. This should improve parking skills. The apparatus attaches to the four corners of the vehicle enabling the driver to fully ascertain the perimeter of the vehicle while training to park.

This apparatus and perimeter marking system will assist beginner and/or student drivers and experienced drivers in learning the dimensions of their vehicle, and therefore enable the user to parallel park more efficiently. Easily attached to the four corners of a vehicle, the apparatus will allow a driving instructor to teach a student to more readily identify the dimensions of their vehicle and the limitations of their mirrors. (FIG. 3)

The system consists of four (4) separate components which are temporarily attached to the vehicle for driver education purposes. The apparatus itself consists of: first, two pieces identical in every manner, measuring 26 inches in length, as finished pieces (see FIGS. 1, 2 and 4) and are to be attached to the front corners of a vehicle. (FIG. 3). The two pieces are to be constructed from wooden/plastic/or other material rods measuring 25 inches in length and 0.25 inches in width, bright florescent orange in color with a one inch sphere bright florescent yellow in color at the top and a 2.5 inch heavy duty suction cup on the bottom.

The two (2) additional components of the parallel parking apparatus and perimeter marking system are also identical in every manner, measuring 38 inches as finished pieces; these two (2) pieces are to be attached to the rear corners of a vehicle. (FIG. 3) Consisting of two wooden/plastic/or other material rods measuring 36 inches in length and 0.25 inches in width, (FIGS. 1, 2 and 4) bright florescent orange in color with a one inch sphere colored bright florescent yellow at the top and a 2.5 inch heavy duty/mechanical suction cup on the bottom.

The parallel parking apparatus/vehicle perimeter marking system sample product was made with wood components and heavy duty suction cups purchased at the local art supply store. Four one inch wooden spheres were purchased and 0.25 inch holes were drilled on center and painted bright florescent yellow. Four 38 inch long by 0.25 inch diameter rods were purchased, two were cut down to a size of 25 inches, all four rods were sanded down to a give them a tapered bottom and then painted bright florescent orange. The spheres were then inserted into the flat end of each of the four wooden rods; the four heavy duty suction cups were attached to the tapered ends of the painted wooden rods by inserting the tapered end into holes drilled on the outside handle of the suction cup, fitting snuggly, a breakaway view is provided. (FIG. 4)

### CROSS REFERENCE TO RELATED APPLICATIONS

### Cross-Reference to Related Applications

The inventor has no previous applications. The inventor found no related patents previously submitted by anyone.

### STATEMENT REGARDING FEDERALLY SPONSORED RESEARCH AND/OR DEVELOPMENT

Scott Lane Gallagher, the inventor, retains all rights to the invention of the parallel parking apparatus and boundary marking system and he has received no federal or state moneys directly or indirectly for the research or development of the same. The prototype, documentation, drawings, instructions and application have been fully funded and prepared by the inventor.

### BACKGROUND OF THE INVENTION

The inventor was teaching his daughter how to drive and how to park when the idea of this invention occurred to him. I made it; she used it, and has not had any accidents while parking. I believe that this would also help others if they were to use this apparatus and perimeter marking system; therefore decided to submit this application for patent.

### SUMMARY OF THE INVENTION

The inventor, wanting to assist drivers whom may have a tendency to hit objects while parking to be more effective drivers came up with this solution. Use of the parallel parking apparatus/vehicle perimeter marking system will possibly help with this problem of new drivers, due to the fact that the driver will become aware of the perimeter of their vehicle through visual apparatus during practice.

The inventor wanted to enable drivers to easily ascertain through the use of existing mirrors with the parallel parking apparatus/vehicle perimeter marking system, the perimeter of their vehicle. It will be advantageous to drivers to practice parking using the parallel parking apparatus/vehicle perimeter marking system because the driver will quickly learn the perimeter of the vehicle.

This product can potentially save damage to life and property when used as a teaching aid for inexperienced drivers. The parallel parking apparatus/vehicle perimeter marking system is easy to use. First the driving instructor/parent would simply attach the four components onto the four corners of the car. (FIG. 3) The student could then begin using the system. The heavy duty suction cups enable the student to enjoy hours of practice.

The parallel parking apparatus/vehicle perimeter marking system was designed to solve the problem of drivers knowing the perimeter of their vehicle. The parallel parking apparatus/vehicle perimeter marking system will enable the driver to ascertain with greater insight if their vehicle will fit in an available parking spot and with practice, allow the driver to park more efficiently.

The parallel parking apparatus/vehicle perimeter marking system will be beneficial to the driving education field, automobile safety field, parking safety, as well as the public safety field. It will enable drivers to become more effective drivers by showing them the perimeter of their vehicle. Use of the parallel parking apparatus/vehicle perimeter marking system is intended to be used as a training tool only. It could possibly save money by helping prevent parking accidents because the driver will have better knowledge of the vehicle's perimeter.

### BRIEF DESCRIPTION OF THE SEVERAL VIEWS OF THE DRAWING

FIG. 1 contains a side view of the parallel parking apparatus and perimeter marking system; the system contains four of these of two sizes for the rear and the back of a vehicle.

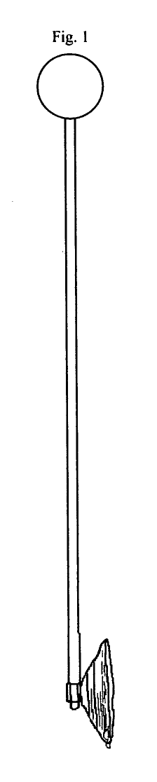

FIG. 2 is a front view of the parallel parking apparatus and perimeter marking system.

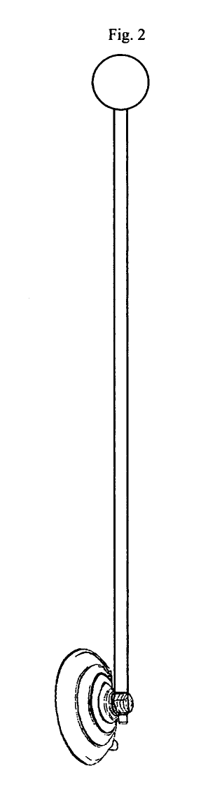

FIG. 3 is a view of the parallel parking apparatus and perimeter marking system on a vehicle.

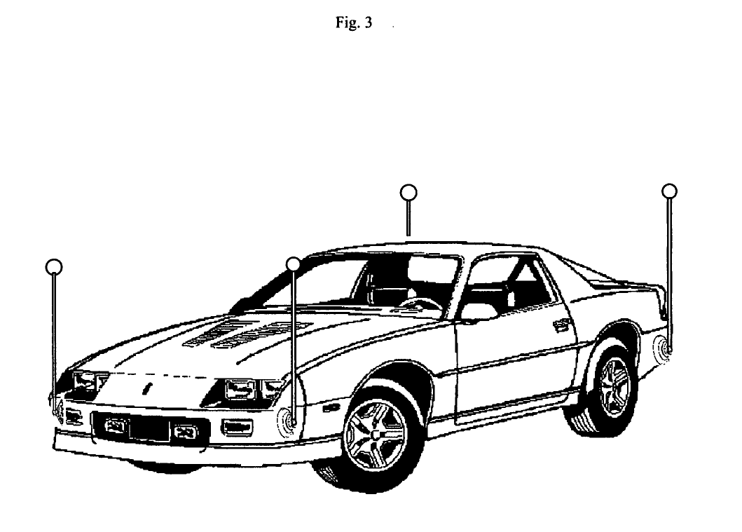

FIG. 4 is a blown apart view of one of the components of the parallel parking apparatus and perimeter marking system.

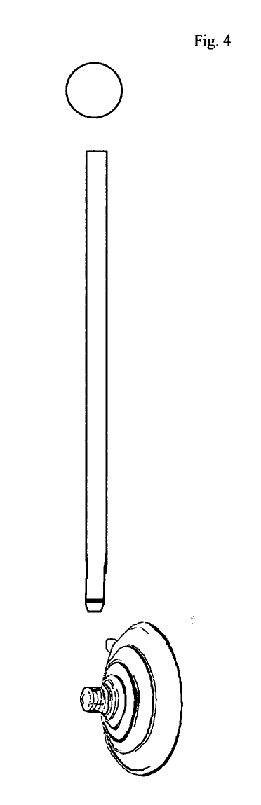

### DETAILED DESCRIPTION OF THE INVENTION

The parallel parking apparatus/vehicle perimeter marking system was invented by Scott Lane Gallagher to enable him to teach his daughter how to park more safely. Many of his daughter's friends had minor accidents while parallel parking and in order to help his daughter overcome this seeming obstacle, he came up with this invention.

The inventor found the components of his idea at the local arts and crafts store, purchased them, painted them and assembled the final product at his residence. The Specifications portion of this application more fully describes the actual construction of the invention.

After some basic driving instruction the inventor took his daughter out to see if his invention would be practical. Cones were set up to assist the student driver in perceiving two parked cars with a space for her to park between them. The parallel parking apparatus and marking system was attached to the vehicle and the student found the markers to be very affective. After two hours of practice the student was parking easily. The student has had no problems parallel parking since and she claims that it is the system that helped her to learn the perimeter of her vehicle.

The parallel parking apparatus was made of wooden components but could easily be manufactured with plastics or other material. Wood was used as it was available to the inventor. Only heavy duty suction cups should be used to assemble this apparatus because it can be used on a moving vehicle without damaging the finish of the vehicle. A video is in the planning stages to demonstrate the use of the system.

No invention of this type has been found in stores, on the internet, listed with the patent office or elsewhere and therefore a patent is being sought.

1. The claim of this invention is to help people learn the perimeter of a vehicle for safer driving by attaching apparatus to vehicle during parking training.

2. The claim of this invention is to improve parking abilities by temporarily marking the perimeter of a vehicle.

3. This apparatus is readily made out of other material other than that used.

4. A training video is in the planning stages.
